(19) United States
(12) Patent Application Publication
(10) Pub. No.: US 2026/0185814 A1
(43) Pub. Date: Jul. 2, 2026

(54) MULTIMODAL SCANNING DEVICE, IMAGING SYSTEM AND METHOD OF OPERATING THE SAME

(71) Applicant: INDUSTRIAL TECHNOLOGY RESEARCH INSTITUTE, HSINCHU (TW)

(72) Inventors: Ting-Wei CHANG, New Taipei City (TW); Chun-Chieh HUANG, Hsinchu City (TW); Fu-Chiang JAN, Hsinchu City (TW); Shih-Chieh LU, Hsinchu City (TW); Shuen-Cheng CHEN, Taichung City (TW); Tsung-Yi TSAI, Miaoli County (TW)

(21) Appl. No.: 19/006,122

(22) Filed: Dec. 30, 2024

(30) Foreign Application Priority Data
Dec. 27, 2024 (TW) 113151340

(51) Int. Cl. G01B 9/02015; G01B 9/02; G01B 9/02004; G01B 9/02091

(52) U.S. Cl. CPC G01B 9/02027; G01B 9/02004; G01B 9/02044; G01B 9/0205; G01B 9/02091

(57) ABSTRACT

A multi-modal scanning device is provided, including an outer tube, a first imaging scanning module, a second imaging scanning module, and an optical coherence tomography module. The outer tube includes a first channel, a second channel, and a third channel spaced apart from each other. The first imaging scanning module is disposed in the first channel and is configured to capture a first image of an area under test. The second imaging scanning module is disposed in the second channel and is configured to capture a second image of the area under test. The optical coherence tomography module is disposed in the third channel and is configured to capture an optical coherence tomography image of a site under test in the area under test.

### CROSS-REFERENCE TO RELATED APPLICATION

This application claims priority to Taiwan Application Serial Number 113151340, filed on Dec. 27, 2024, which is herein incorporated by reference in its entirety.

### BACKGROUND

### Field of Invention

The technical field relates to multimodal scanning device, imaging system and method of operating the same.

### Description of Related Art

Endoscopes have been used in clinical practice for decades. Endoscopes are medical instruments that enter the body through tubes to observe the internal conditions of the body. Traditional endoscopic techniques rely primarily on visible light to observe the general structure of the surface of body cavities. With the emergence of optical coherence tomography (OCT) technology, biological tissues can be scanned and tissue images can be obtained without damaging the tissues, which has a wider range of uses for endoscopes.

### SUMMARY

One embodiment of the present disclosure provides a multimodal scanning device comprising an outer tube, a first imaging scanning module, a second imaging scanning module, and an optical coherence tomography module. The outer tube comprises a first channel, a second channel, and a third channel spaced apart from each other. The first imaging scanning module is disposed in the first channel to capture a first image from an area under test. The second imaging scanning module is disposed in the second channel to capture a second image from the area under test. The optical coherence tomography module passes through and is disposed in the third channel to capture an optical coherence tomography image from a site under test in the area under test.

Another embodiment of the present disclosure provides a multimodal imaging system comprising: the multimodal scanning device as above mentioned, a display device, a driving device, and a control device. The display device is adjacent to the multimodal scanning device. The driving device is connected to the optical coherence tomography module, and is configured to drive the optical coherence tomography module to slide and bend. The control device is communicatedly connected to the first imaging scanning module, the second imaging scanning module, the optical coherence tomography module, and the display device, and is configured to display the first image captured by the first imaging scanning module, the second image captured by the second imaging scanning module, and the optical coherence tomography image captured by the optical coherence tomography module on the display device.

Another embodiment of the present disclosure provides a method of operating multimodal scanning device, comprising: providing the multimodal scanning device as above mentioned; performing an observation by the first imaging scanning module, the second imaging scanning module, or a combination thereof, and moving the outer tube to the area under test; moving the optical coherence tomography module to be adjacent to the site under test in the area under test; and performing an optical coherence tomography by the optical coherence tomography module.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion. The disclosure can be more fully understood by reading the following detailed description of the embodiment, with reference made to the accompanying drawings as follows:

FIG. 1 depicts a partial perspective view of a multimodal scanning device according to an embodiment of the present disclosure.

FIG. 2 is a perspective view of FIG. 1.

FIG. 3 is a schematic diagram of the multimodal imaging system according to an embodiment of the present disclosure.

FIG. 4 is a flow chart of a method for operating a multimodal scanning device according to an embodiment of the present disclosure.

FIG. 5 is a schematic diagram of an adjustable state of an optical coherence tomography module according to one embodiment of the present disclosure.

FIG. 6 is a plan view of the optical coherence tomography module in the adjustable state according to an embodiment of the present disclosure.

FIG. 7 is a schematic diagram of a bent state of the optical coherence tomography module according to an embodiment of the present disclosure.

FIG. 8 is a schematic diagram of the bent state of the optical coherence tomography module according to another embodiment of the present disclosure.

FIG. 9 is a schematic diagram of a scanning positioning of the multimodal scanning device according to an embodiment of the present disclosure.

### DETAILED DESCRIPTION

The following disclosure provides detailed description of many different embodiments, or examples, for implementing different features of the provided subject matter. These are, of course, merely examples and are not intended to limit the present disclosure but to illustrate it. In addition, various embodiments disclosed below may combine or substitute one embodiment with another, and may have additional embodiments in addition to those described below in a beneficial way without further description or explanation. In the following description, many specific details are set forth to provide a more thorough understanding of the present disclosure. It will be apparent, however, to those skilled in the art, that the present disclosure may be practiced without these specific details.

Further, spatially relative terms, such as “beneath,” “over” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising”, or “includes” and/or “including” or “has” and/or “having” when used in this specification, specify the presence of stated features, regions, integers, steps, operations, elements, and/or components, but do not preclude the presence or addition of one or more other features, regions, integers, steps, operations, elements, components, and/or groups thereof.

Further, when a number or a range of numbers is described with “about,” “approximate,” and the like, the term is intended to encompass numbers that are within a reasonable range considering variations that inherently arise during manufacturing as understood by one of ordinary skill in the art. For example, the number or range of numbers encompasses a reasonable range including the number described, such as within +/−10% of the number described, based on known manufacturing tolerances associated with manufacturing a feature having a characteristic associated with the number. Still further, the present disclosure may repeat reference numerals and/or letters in the various examples. This repetition is for the purpose of simplicity and clarity and does not in itself dictate a relationship between the various embodiments and/or configurations discussed.

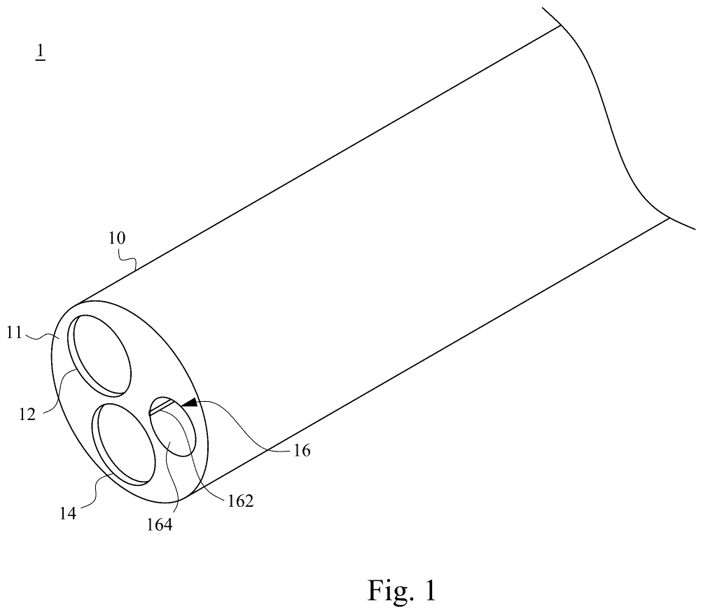

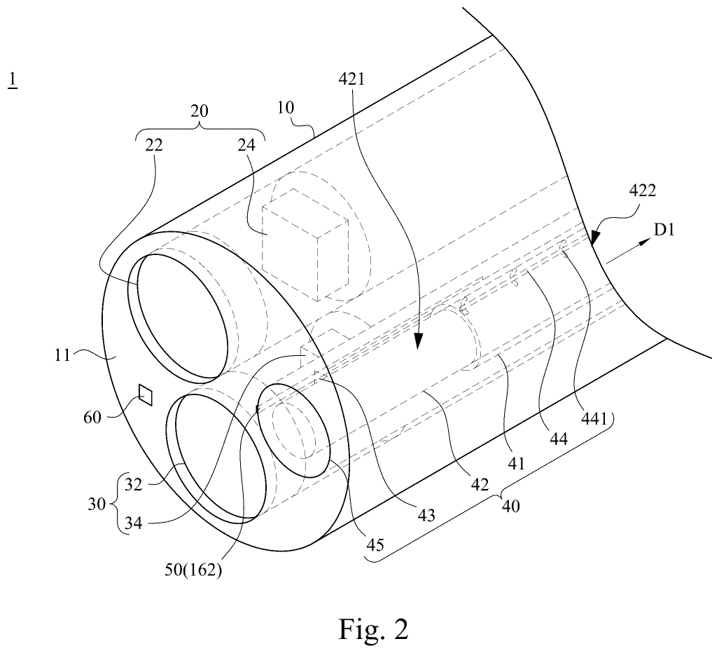

Please refer to FIGS. 1 and 2, FIG. 1 depicts a partial perspective view of a multimodal scanning device according to an embodiment of the present disclosure, FIG. 2 is a perspective view of FIG. 1. A multimodal scanning device 1 comprises an outer tube 10, a first imaging scanning module 20, a second imaging scanning module 30, an optical coherence tomography module 40, a positioning portion 50, and a sensing light source 60. In some examples, the implementation materials of the related components of the multimodal scanning device 1 disclosed herein are all biocompatible materials, please refer to the following description for details.

The outer tube 10 includes an end surface 11, a first channel 12, a second channel 14, and a third channel 16, and the first channel 12, the second channel 14, and the third channel 16 are spaced apart from each other. In some examples, the third channel 16 includes a first sliding member 162, a first sliding member 162 disposed on an inner wall 164 of the third channel 16. In some examples, a diameter of the outer tube 10 includes, but is not limited to 1 mm to about 5 mm, such as 1 mm, 2 mm, 3 mm, 4 mm, 5 mm, or any value between any two of these values, or more than 5 mm. In some examples, apertures of the first channel 12 and the second channel 14 are the same or are different, including, but not limited to 0.5 to about 3 mm, such as 0.5 mm, 1 mm, 1.5 mm, 2 mm, 2.5 mm, 3 mm, or any value between any two of these values. An aperture of the third channel 16 includes, but is not limited to 0.1 to about 1 mm, such as 0.1 mm, 0.3 mm, 0.5 mm, 0.7 mm, 0.8 mm, 0.9 mm, 1 mm, or any value between any two of these values.

The first imaging scanning module 20 is disposed in the first channel 12. In some examples, the first imaging scanning module 20 includes a first lens 22 and a first sensor 24. The first lens 22 is disposed at an end (distal end) of the first channel 12, the first sensor 24 is disposed in the first channel 12 and positioned relative to the first lens 22. In some examples, after the sensing light source 60 or an external light source illuminates an object, a reflected light passes through the first lens 22. The first lens 22 can have a focusing effect. In some examples, the first sensor 24 includes, but is not limited to complementary metal oxide semiconductor (CMOS) image sensor used to facilitate integration of the first sensor 24 into the first channel 12 and miniaturization of the overall device. In some examples, the first lens 22 and the first sensor 24 receive all wavelengths of visible light.

The second imaging scanning module 30 is disposed in the second channel 14. In some examples, second imaging scanning module 30 includes a second lens 32 and a second sensor 34. The second lens 32 is disposed at an end (distal end) of the second channel 14, the second sensor 34 is disposed in the second channel 14 and positioned relative to the second lens 32. In some examples, after the sensing light source 60 or the external light source illuminates the object, the reflected light passes through the second lens 32. The second lens 32 can have a focusing effect, or filtering a specific wavelength. For example, when the environment is filled with blood, the reflected light passes through the second lens 32 which filters out the wavelength range of about 500 to 600 nanometers, so that the field of vision is clear. In some examples, second sensor 34 includes, but is not limited to CMOS image sensor used to facilitate integration of the second sensor 34 into the second channel 14 and miniaturization of the overall device. In some examples, when the second sensor 34 has the effect of filtering a specific wavelength, the second lens 32 is configured as a general lens that receives the full wavelength of visible light. In some examples, the second sensor 34 and the second lens 32 both have the effect of filtering specific wavelengths. In some examples, when the second sensor 34 has the effect of detecting general visible light, filtering specific wavelength visible light, detecting fluorescence, detecting infrared light (such as near infrared light), or a combination thereof. For example, after a lesion location is marked by antibodies with fluorescent, the light source is detected by a second sensor 34 that can detect the wavelength of fluorescent.

In some examples, first imaging scanning module 20 is a light source receiving all wavelengths of visible light, and second imaging scanning module 30 is a light source receiving and filters specific blood wavelengths, so that a field of view is still clear in the environment filled with blood. In some examples, the first imaging scanning module 20 is a light source receiving all wavelengths of visible light, and the second imaging scanning module 30 is a light source receiving fluorescent light, infrared light (such as near-infrared light), etc. It should be noted that the functions of the first imaging scanning module 20 and the second imaging scanning module 30 can be replaced and are not limited thereto. In some examples, the image can also have a two-dimensional, two-and-a-half-dimensional or three-dimensional visual effect by using the first imaging scanning module 20 and the second imaging scanning module 30 simultaneously.

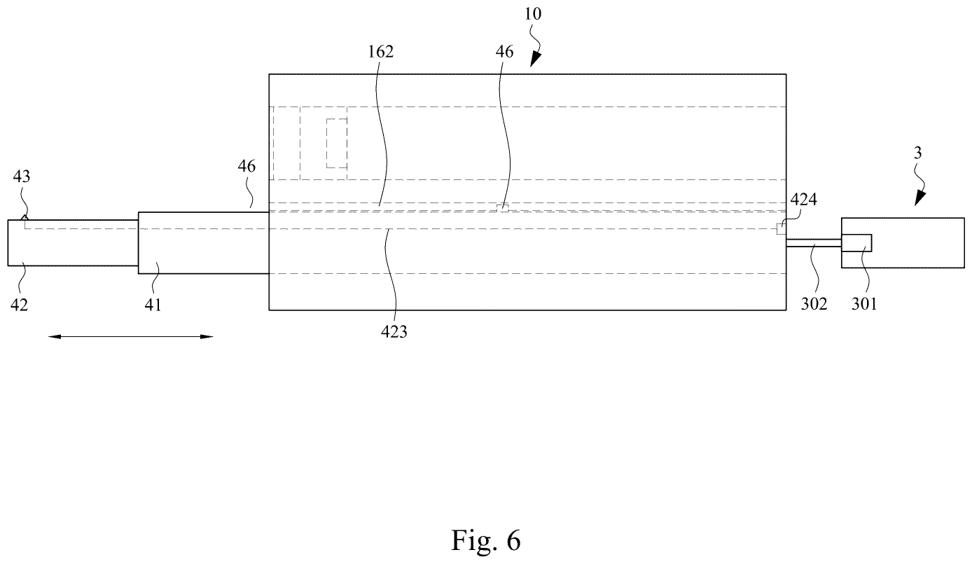

The optical coherence tomography module 40 passes through and is disposed in the third channel 16. In some examples, the optical coherence tomography module 40 includes: a scanning tube 41, a scanning probe 42, a scanning light source 43, a guiding element 44, a protective part 45, and a second sliding member 46 (as shown in FIG. 6). The scanning tube 41 passes through and is disposed in third channel 16. In some examples, the scanning tube 41 is movably connected to the first sliding member 162 by the second sliding member 46, so that the scanning probe 42 is driven by the scanning tube 41 to extend out of a distal end of the outer tube 10. In some examples, the distance that the scanning tube 41 extends is determined according to the needs, including but not limited to about 0.01 cm to about 5 cm. In some examples, the material of the scanning tube 41 includes, but is not limited to, a biocompatible material and has a flexural characteristic.

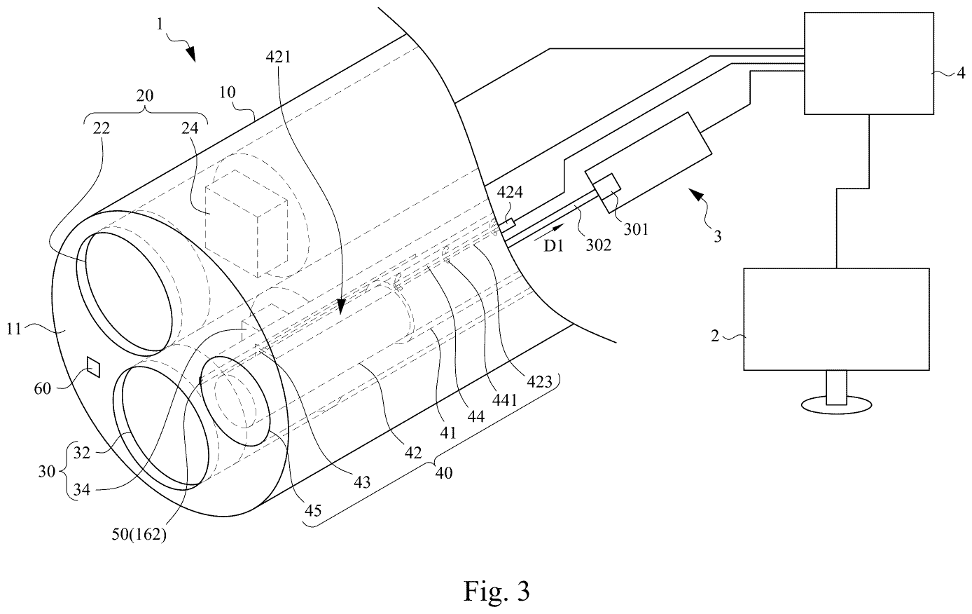

The scanning probe 42 passes through the scanning tube 41. In some examples, the scanning probe 42 includes a free end portion 421 and a connecting end portion 422, the scanning tube 41 covers the connecting end portion 422. The free end portion 421 and the connecting end portion 422 are opposite to each other. In some examples, an internal of the scanning probe 42 includes, but is not limited to an optical fiber 423, an optical fiber connector 424 (as shown in FIG. 3), an optical lens and an optical prism (not shown in figure). A distal end of the optical fiber 423 is connected to the scanning light source 43, a proximal end of the optical fiber 423 is connected to the optical fiber connector 424. The optical fiber connector 424 is disposed terminal ends (proximal ends) of the scanning tube 41 and the scanning probe 42. One end of the optical fiber connector 424 is connected to the optical fiber 423, the other end is communicatedly connected to a control device 4 to transmit the scanned image to the control device 4 and display on a display device 2 (as shown in FIG. 3). In some embodiments, the scanning tube 41 and the scanning probe 42 are driven by the drive motor 301 through the coupling 302 and driven by the control device 4 to rotate along the longitudinal direction D1 at a predetermined rotational speed, so that when performing the optical coherence tomography, it can rotate 360 degrees along the axis, also known as radial scanning. For example, in the early stages of performing the optical coherence tomography, radial scanning is used to observe the location of lesions in all orientations of the area under test. In some examples, the material of the scanning probe 42 includes, but is not limited to a biocompatible material and has a flexible property.

The scanning light source 43 is disposed at the scanning probe 42 to provide a light source for optical coherence tomography. In some examples, the scanning light source 43 is disposed at the free end portion 421 of the scanning probe 42. In some examples, the scanning light source 43 is disposed at a side of the free end portion 421 of the scanning probe 42 to perform side scanning. In some examples, the scanning light source 43 is disposed at a front end (or a distal end, i.e., an end away from the connecting end portion 422) of the free end portion 421 of the scanning probe 42 to perform a front-end scanning. In some examples, the scanning light source 43 includes a light source with a wavelength of from 800 nm to 1700 nm. As the depth of the tissue increases, a longer wavelength is used, and vice versa. In some examples, in the optical coherence tomography module 40, a light is emitted by the scanning light source 43 connected to the distal end of the optical fiber 423 through an optical mechanism in the scanning probe 42, and a signal beam is emitted along a direction substantially orthogonal to an axial direction D1. Next, a return beam reflected by the signal beam is acquired by the scanning probe 42, thereby a tomographic image of a region to be measured in a direction substantially orthogonal to the scanning probe 42 is created. The proximal end of the optical fiber 423 is connected to an optical tomography device (such as display device 2 as shown in FIG. 3), and the return beam from the area under test is transmitted into the optical fiber 423 and then transmitted back to the optical tomography device.

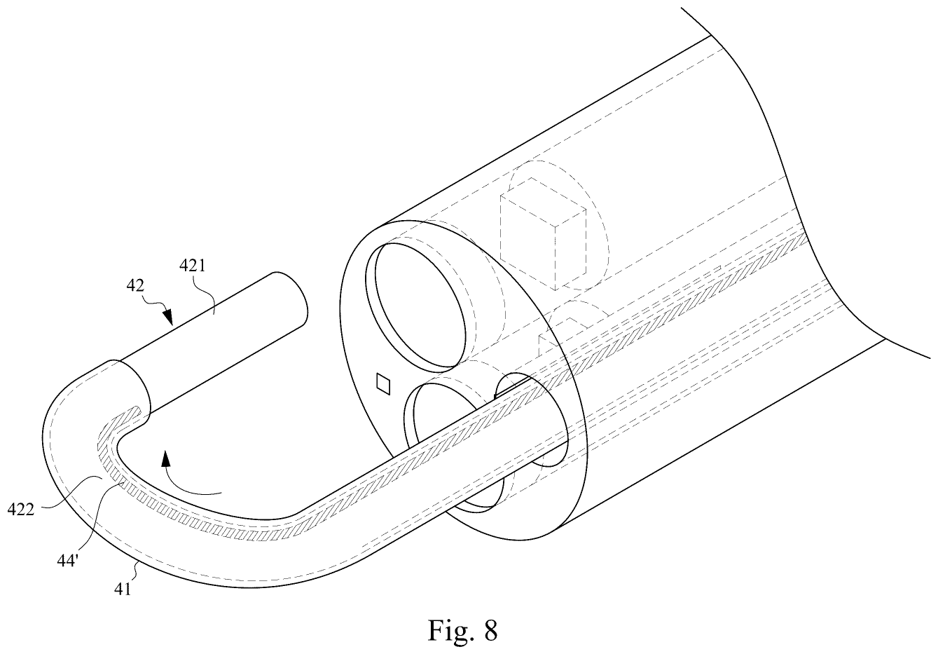

The guiding element 44 is disposed at the scanning tube 41 to drive the scanning tube 41 together with the connecting end portion 422 of the scanning probe 42 to adjust the bending angle relative to the outer tube 10, thereby adjusting a direction of the free end portion 421. In some examples, the guiding element 44 is disposed on a relative inner side of an outer surface of the scanning tube 41, one end of the guiding element 44 is fixed to a free end (distal end) of the scanning tube 41, and the other end is positioned at a terminal end (proximal end) of the scanning tube 41, so as to drive the scanning tube 41 and the scanning probe 42 to bend. In some examples, an end of the guiding element 44 positioned at the terminal end of the scanning tube 41 is drivingly connected to the drive motor 301, and drive motor 301 is communicatedly connected to the control device 4, so that the drive motor 301 is driven by the control device 4 (as shown in FIG. 3) to drive the scanning tube 41 together with the scanning probe 42 to adjust the bending angle relative to the outer tube 10. In other examples, a way of the scanning probe 42 driven by the guiding element 44 to adjust the bending includes, but is not limited to driven by motor electronic control (such as the drive motor 301) or controlled manually. In some examples, the optical coherence tomography module 40 further comprises a plurality of limiting members 441, the plurality of limiting members 441 are spaced apart from each other and limit the guiding element 44 on the scanning tube 41, so that the guiding element 44 is substantially attached to the scanning tube 41 and the scanning tube 41 and the scanning probe 42 can be effectively driven, that is, the scanning probe 42 is driven when the scanning tube 41 is bent. In some examples, one of the plurality of limiting members 441 is corresponding to the positioning portion 50. In some examples, a number of the plurality of limiting members 441 can be adjusted according to the needs. In some examples, a material of the guiding element 44 is a biocompatible material, including but not limited to a metal wire material, such as titanium, stainless steel, cobalt-chrome, and other metal implants, in which the material of the guiding element 44 is selected based on clinically biocompatible materials that can achieve high performance. In some other examples, a guiding element 44′can also be inserted to, limited to, and between a relative inner side of an inner surface of the scanning tube 41 (as shown in FIG. 8) and the scanning probe 42. In some examples, the connecting end portion 422 of the scanning probe 42 is driven by the guiding element 44 to bend and move at an angle of about 0 degree to about 50 degrees, and the angle includes but is not limited to 0 degree, 10 degrees, 20 degrees, 30 degrees, 40 degrees, 50 degrees, or any value between any two of these values.

The protective part 45 movably covers the free end portion 421 of the scanning probe 42 to keep the scanning probe 42 free from contamination. In some examples, the protective part 45 can movably cover a distal end of the third channel 16. In some examples, the material of the protective part 45 includes, but is not limited to biocompatible acrylic. In some examples, the protective part 45 is a protective cover.

The second sliding member 46 is disposed on an outer side of the scanning tube 41, and is correspondingly and movably connected to the first sliding member 162, so that the scanning probe 42 is driven by the scanning tube 41 to extend out of the distal end of the outer tube 10 (as shown in FIG. 6).

In some examples, the second sliding member 46 is a pulley, the first sliding member 162 is a track, and the pulley slides in the track, but is not limited to these examples. In some examples, a movement way of the pulley includes, but is not limited to, driven by motor electronic control (such as the drive motor 301) or controlled manually.

The positioning portion 50 is disposed on the third channel 16. In some examples, the positioning portion 50 includes a coated metal as a highly reflective and low-absorption alignment mark. In some examples, coated metal includes, but is not limited to, titanium (Ti), titanium alloy, stainless steel or other biocompatible metals, or a combination thereof. In other examples, the positioning portion 50 is disposed on the end surface 11 of the outer tube 10. The position of the positioning portion 50 can be set at any position on the end surface 11 according to the needs.

The sensing light source 60 is disposed on the end surface 11 of the outer tube 10, the sensing light source 60 is used as a light source for providing the first imaging scanning module 20 and the second imaging scanning module 30. In some examples, the sensing light source 60 includes, but is not limited to, a light emitting diode (LED). In some examples, the sensing light source 60 and the positioning portion 50 are spaced apart from each other. In other examples, the sensing light source 60 and the positioning portion 50 are adjacent to each other.

FIG. 3 is a schematic diagram of the multimodal imaging system according to an embodiment of the present disclosure. In some examples, as shown in FIG. 3, the present disclosure provides a multimodal imaging system, comprising the multimodal scanning device 1, display device 2, driving device 3 and control device 4 as described above. In some examples, the display device 2 displays the scanned image through a screen.

The driving device 3 is drivingly connected to the optical coherence tomography module 40, and is configured to drive the optical coherence tomography module 40 to slide, rotate and bend. In some examples, the driving device 3 includes, but is not limited to, the drive motor 301, coupling 302, etc. The drive motor 301 is disposed at the proximal end of the scanning tube 41, the coupling 302 is connected between the drive motor 301 and the scanning tube 41. In some examples, the drive motor 301 includes a first drive motor, a second drive motor, and a third drive motor. The second sliding member 46 (as shown in FIG. 6) is driven by the first drive motor to move in the first sliding member 162 via the coupling 302; the second drive motor is drivingly connected to the proximal end of the guiding element 44 to drive the scanning probe 42 to adjust the bending; the scanning tube 41 is driven by the third drive motor via the coupling 302 to move along the long axis direction D1 at a predetermined rotational speed. In some examples, drive motor 301 is communicatedly connected to the control device 4, and drive motor 301 is operated by the control device 4.

The control device 4 is communicatedly connected to the first imaging scanning module 20, the second imaging scanning module 30, the optical coherence tomography module 40, and the display device 2. In some examples, the communicatedly connected way includes, but is not limited to, wired transmission or wireless transmission. In some examples, the control device 4 is configured to display the first image captured by the first imaging scanning module 20, the second image captured by the second imaging scanning module 30, and the optical coherence tomography image captured by the optical coherence tomography module 40 on the display device 2, so that the operator can timely adjust according to the image presentation status and scanning image status.

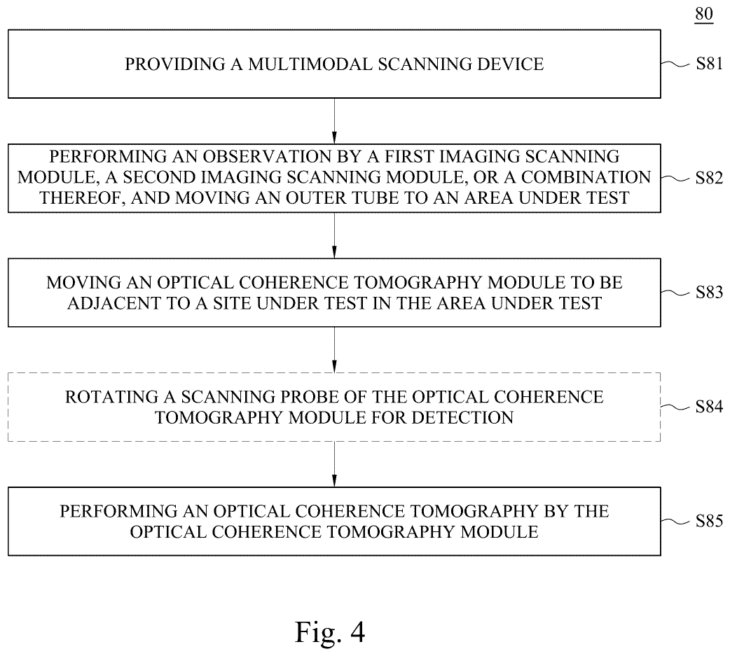

In order to describe the method of operating the multimodal scanning device in detail, the following will be explained with FIGS. 3 to 9. It should be understood that the steps mentioned in FIG. 4, although a series of operations or steps are used below to describe the method disclosed herein, an order of these operations or steps should not be construed as a limitation to the present disclosure. For example, some operations or steps may be performed in a different order and/or other steps may be performed at the same time. In addition, all shown operations, steps and/or features are not required to be executed to implement an embodiment of the present disclosure. In addition, each operation or step described herein may include a plurality of sub-steps or actions.

Please refer to FIG. 4, FIG. 4 is a flow chart of a method for operating the multimodal scanning device according to an embodiment of the present disclosure. The method 80 for operating the multimodal scanning device includes, in step S81, providing the multimodal scanning device 1 as above mentioned; next, in step S82, performing an observation by the first imaging scanning module, the second imaging scanning module, or a combination thereof, and moving the outer tube to the area under test; next, in step S83, moving the optical coherence tomography module and extending out of the outer tube to be adjacent to the site under test in the area under test; next, in step S84, rotating the scanning probe of the optical coherence tomography module for detection; next, in step S85, performing the optical coherence tomography by the optical coherence tomography module. The detailed steps are described below.

Please refer to FIGS. 3 and 4 at the same time, in the step S82, an observation is performed by the first imaging scanning module, the second imaging scanning module, or a combination thereof, and the outer tube is moved to the area under test. Specifically, in order to move the outer tube 10 of the multimodal scanning device 1 to the area under test, the position of the area under test is observed by the first imaging scanning module 20, the second imaging scanning module 30, or a combination thereof, and then the outer tube 10 is moved to the area under test. For example, when the area under test is filled with blood, the first imaging scanning module 20 that receives the full wavelength of visible light with the second imaging scanning module 30 that can filter out the optical wavelength of blood, so that the field of vision is clear and the area under test is easy to reach. For another example, when the site under test of the area under test is marked by the fluorescent, the first imaging scanning module 20 that receives all wavelengths of visible light and the second imaging scanning module 30 that can detect fluorescent wavelengths are used to quickly reach the area under test.

Please refer to FIGS. 4 to 6, FIG. 5 is a schematic diagram of an adjustable state of the optical coherence tomography module according to one embodiment of the present disclosure, FIG. 6 is a plan view of the optical coherence tomography module in the adjustable state according to an embodiment of the present disclosure. In the step S83, the scanning tube outer tube of the optical coherence tomography module is moved until to be adjacent to the site under test of the area under test. Specifically, when the outer tube 10 encounters a structural obstacle of the area under test, the second sliding member 46 on the scanning tube 41 of the optical coherence tomography module 40 is movably connected to the first sliding member 162, so that the scanning tube 41 extends out of the outer tube 10. A distance that the scanning tube 41 extends beyond the outer tube 10 can be extended according to the needs until the scanning probe 42 is adjacent to the site under test in the area under test. For example, when the outer tube 10 encounters a space obstruction formed by the nasal concha in the nasal cavity and cannot go deeper, the scanning tube 41 is extended out of the outer tube 10 so that the scanning probe 42 can scan the lesion in a close distance.

In some examples, in the step S84, the scanning probe of the optical coherence tomography module is rotated for detection. Specifically, the scanning probe 42 of the optical coherence tomography module 40 is driven to rotate in the manner described above, such as by the third drive motor of the drive motor 301, so that the scanning tube 41 and the scanning probe 42 are rotated along the long axis direction D1. In some examples, the step S83 and the step S84 may be performed simultaneously according to the needs, the order may be adjusted according to the needs, or the step S84 may not be performed according to the needs, but is not limited to these examples.

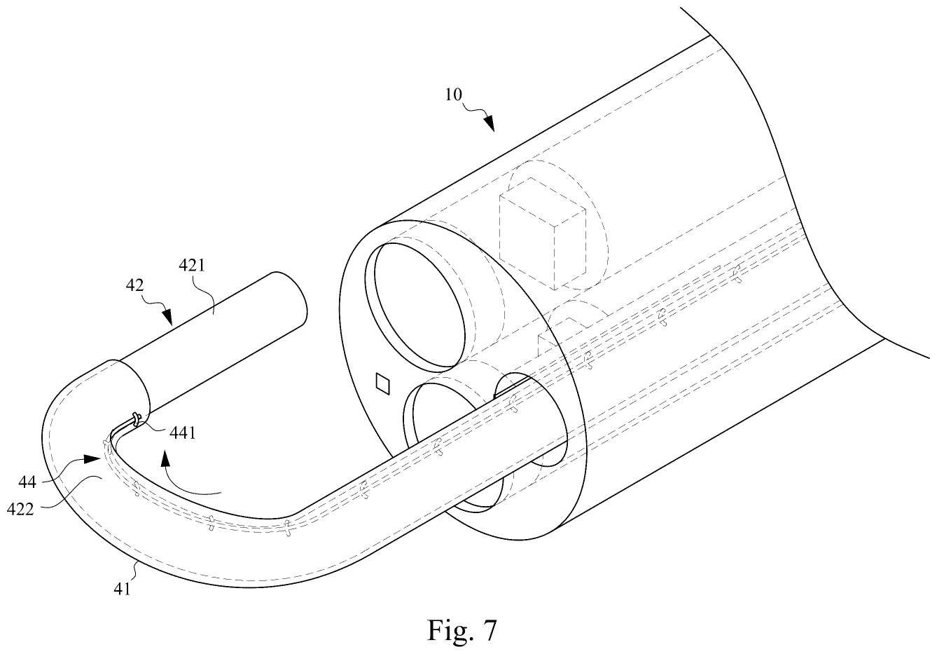

Please refer to FIGS. 4 and 7, FIG. 7 is a schematic diagram of a bent state of the optical coherence tomography module according to an embodiment of the present disclosure. Specifically, when the site under test is not located directly in front of the outer tube 10, the connecting end portion 422 of the scanning probe 42 and the distal end of the scanning tube 41 are driven by the guiding element 44 and the bending angle is adjusted, thereby moving the free end portion 421 until being adjacent to the site under test in the area under test. For example, when the lesion is located at the bending site of the nasal cavity rather than directly in front of the outer tube 10, the connecting end portion 422 of the scanning probe 42 and the distal end of the scanning tube 41 are driven by the guiding element 44 drives to bend, so that the free end portion 421 is directed toward the direction of the lesion and can accurately perform the optical coherence tomography.

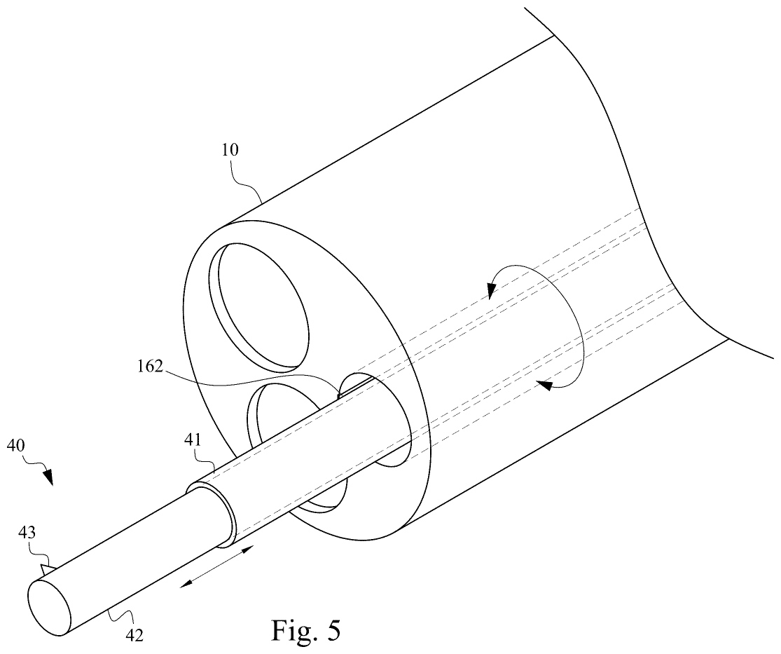

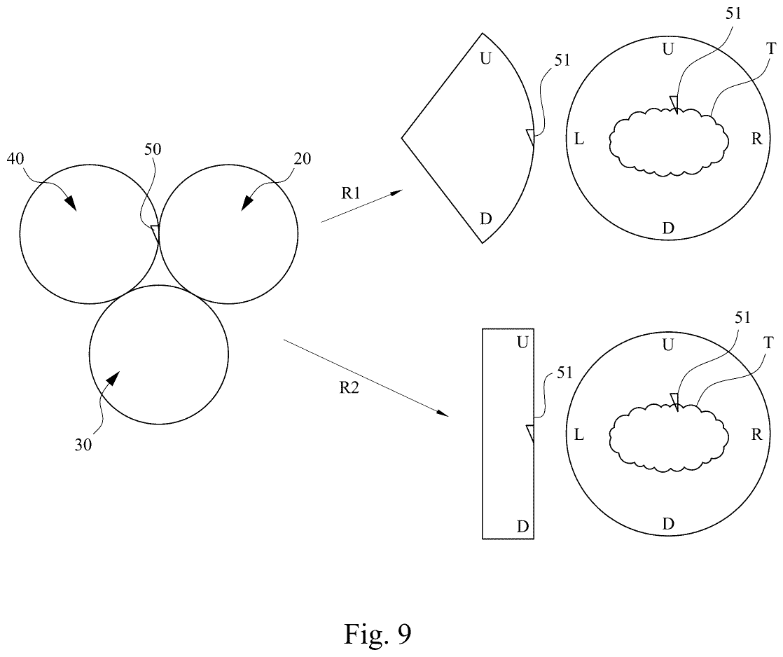

Please refer to FIGS. 4 and 9, FIG. 9 is a schematic diagram of the scanning positioning of the multimodal scanning device according to an embodiment of the present disclosure. In the step S85, the optical coherence tomography is performed by the optical coherence tomography module. Specifically, when optical coherence tomography is performed, the optical coherence tomography is performed based on the positioning portion 50 to obtain an orientation in real time. The side scanning method is taken as an example, in the left side of FIG. 9, the positioning portion 50 is disposed at the optical coherence tomography module 40 adjacent to the first imaging scanning module 20. The upper middle side of FIG. 9 is a schematic side view of the optical coherence tomography module 40 scanning along a side scanning path R1, such as the scanning probe 42 (as shown in FIG. 5) with the scanning light source 43 in scans from the upper U to the lower D. The upper right side of FIG. 9 is a real-time optical coherence tomography image, and the image from the top U to the bottom D and the left L to the right R is shown. In the absence of imaging software intervention, the positioning portion 50 is presented in the image as a positioning mark 51, and the position is equivalent to the actual position at the multimodal scanning device 1. When the positioning mark 51 is presented at a position slightly above the center of the screen, the target T presented in the center of the screen can be determined in time.

The front-end scanning method is taken as an example, in the left side of FIG. 9, the positioning portion 50 is also disposed at the optical coherence tomography module 40 adjacent to the first imaging scanning module 20. The lower middle side of FIG. 9 is a schematic side view of the optical coherence tomography module 40 scanning along a front-end scanning path R2, such as the scanning probe 42 (as shown in FIG. 5) with the scanning light source 43 in scans from the upper U to the lower D. The lower right side of FIG. 9 is a real-time optical coherence tomography image, and the image from the top U to the bottom D and the left L to the right R is shown. In the absence of imaging software intervention, the positioning portion 50 is presented in the image as a positioning mark 51, and the position is equivalent to the actual position at the multimodal scanning device 1. Similarly, when the positioning mark 51 is presented at a position slightly above the center of the screen, the target T presented in the center of the screen can be determined in time.

In some examples, the position of the positioning mark 51 in the image can also be changed by using imaging software according to the needs. For example, when positioning mark 51 is actually located above the center, the mark T is displayed in the center of the screen, and the positioning mark 51 is modified down to the center of the screen using imaging software, and scanning is performed in an intuitive way.

Accordingly, the present disclosure provides the multimodal scanning device and method of operating thereof, in which two imaging scanning modules and an optical coherence tomography module are used to instantly identify the area under test and the site under test, in which the scanning tube and scanning probe of the optical coherence tomography module slide by the sliding member, bend by the guiding element, and rotate by the drive motor through the coupling to accurately perform the optical coherence tomography on the site under test.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. A multimodal scanning device, comprising:
an outer tube comprising a first channel, a second channel, and a third channel spaced apart from each other;
a first imaging scanning module disposed in the first channel to capture a first image from an area under test;
a second imaging scanning module disposed in the second channel to capture a second image from the area under test; and
an optical coherence tomography module passing through and disposed in the third channel to capture an optical coherence tomography image from a site under test in the area under test.

2. The multimodal scanning device of claim 1, wherein
the first imaging scanning module is configured to receive a light source comprising a visible light source, a fluorescent light source, or an infrared light source; and
the second imaging scanning module is configured to receive a light source comprising a visible light source, a fluorescent light source, or an infrared light source.

3. The multimodal scanning device of claim 2, wherein the light source that the first imaging scanning module is configured to receive is different from the light source that the second imaging scanning module is configured to receive.

4. The multimodal scanning device of claim 1, wherein the optical coherence tomography module comprises:
a scanning tube passing through and disposed in the third channel, comprising a free end and a terminal end opposite to the free end;
a scanning probe comprising a connecting end portion and a free end portion opposite to each other, the scanning tube covering the connecting end portion; and
a guiding element disposed at the scanning tube to drive the scanning tube together with the scanning probe to adjust a bending angle relative to the outer tube, thereby adjusting a direction of the free end portion.

5. The multimodal scanning device of claim 4, wherein the guiding element disposed on a relative inner side of an outer surface of the scanning tube, and one end of the guiding element is fixed to the free end of the scanning tube, and the other end is positioned at the terminal end of the scanning tube to drive the scanning tube together with the scanning probe to bend.

6. The multimodal scanning device of claim 5, wherein the optical coherence tomography module further comprises a plurality of limiting members, the plurality of limiting members are spaced apart from each other and limit the guiding element on the scanning tube, so that the scanning probe is driven when the scanning tube is bent.

7. The multimodal scanning device of claim 4, wherein the guiding element passes through between a relative inner side in the scanning tube and the scanning probe.

8. The multimodal scanning device of claim 4, wherein the third channel comprises a first sliding member disposed on an inner wall of the third channel; and the optical coherence tomography module further comprises a second sliding member disposed on the scanning tube and movably connected to the first sliding member.

9. The multimodal scanning device of claim 1, further comprises a positioning portion disposed on the third channel, wherein an orientation is obtained in real time when an optical coherence tomography is performed based on the positioning portion.

10. The multimodal scanning device of claim 9, wherein the positioning portion comprises a coated metal.

11. The multimodal scanning device of claim 1, further comprises a positioning portion disposed on an end surface of the outer tube.

12. A multimodal imaging system, comprising:
the multimodal scanning device as claimed in claim 1;
a display device adjacent to the multimodal scanning device;
a driving device connected to the optical coherence tomography module, and configured to drive the optical coherence tomography module to slide and bend; and
a control device communicatedly connected to the first imaging scanning module, the second imaging scanning module, the optical coherence tomography module, and the display device, and configured to display the first image captured by the first imaging scanning module, the second image captured by the second imaging scanning module, and the optical coherence tomography image captured by the optical coherence tomography module on the display device.

13. A method of operating multimodal scanning device, comprising:
providing the multimodal scanning device as claimed in claim 1;
performing an observation by the first imaging scanning module, the second imaging scanning module, or a combination thereof, and moving the outer tube to the area under test;
moving the optical coherence tomography module to be adjacent to the site under test in the area under test; and
performing an optical coherence tomography by the optical coherence tomography module.

14. The method of claim 13,
wherein the first imaging scanning module is configured to receive a light source comprising a visible light source, a fluorescent light source, or an infrared light source; the second imaging scanning module is configured to receive a light source comprising a visible light source, a fluorescent light source, or an infrared light source,
wherein the step of performing the observation by the first imaging scanning module, the second imaging scanning module, or the combination thereof comprises: performing the observation by the first imaging scanning module and the second imaging scanning module, and moving the outer tube to the area under test.

15. The method of claim 14,
wherein the light source that the first imaging scanning module is configured to receive is different from the light source that the second imaging scanning module is configured to receive,
wherein the step of performing the observation by the first imaging scanning module, the second imaging scanning module, or the combination thereof further comprises: performing the observation by the light sources that the light source that the first imaging scanning module is configured to receive is different from the light source that the second imaging scanning module is configured to receive, and moving the outer tube to the area under test.

16. The method of claim 13,
wherein the third channel comprises a first sliding member disposed on an inner wall of the third channel; the optical coherence tomography module comprises a scanning tube and a second sliding member disposed on the scanning tube and movably connected to the first sliding member,
wherein the step of moving the optical coherence tomography module comprises: extending the scanning tube out of the outer tube by the second sliding member movably connected to the first sliding member.

17. The method of claim 13,
wherein the optical coherence tomography module comprises:
a scanning tube passing through and disposed in the third channel;
a scanning probe connected to the scanning tube, the scanning probe comprising:
a connecting end portion, the scanning tube covering the connecting end portion; and
a free end portion opposite to the connecting end portion;
a scanning light source disposed at the free end portion of the scanning probe to provide a light source of the optical coherence tomography; and
a guiding element disposed at the scanning tube,
wherein the step of moving the optical coherence tomography module comprises: driving the scanning probe by the guiding element and adjusting a bending angle, thereby moving the scanning probe to be adjacent to the site under test in the area under test.

18. The method of claim 17,
wherein the guiding element is disposed on a relative inner side of an outer surface of the scanning tube, and one end of the guiding element is fixed to a free end of the scanning tube, and the other end is positioned at a terminal end of the scanning tube;
wherein the step of moving the optical coherence tomography module further comprises: driving the scanning probe by the guiding element and adjusting the bending angle, thereby moving the free end portion in a direction adjacent to the site under test in the area under test.

19. The method of claim 17,
wherein the optical coherence tomography module further comprises a plurality of limiting members, the plurality of limiting members are spaced apart from each other and limit the guiding element on the scanning tube;
wherein the step of moving the optical coherence tomography module further comprises: driving the connecting end portion of the scanning probe by the guiding element, so that the scanning probe is driven when the scanning tube is bent.

20. The method of claim 16,
wherein the multimodal scanning device further comprises a positioning portion disposed on the third channel,
wherein the performing the optical coherence tomography comprises performing the optical coherence tomography based on the positioning portion to obtain an orientation in real time.
